(19) United States
(12) Patent Application Publication
(10) Pub. No.: US 2005/0242322 A1
(43) Pub. Date: Nov. 3, 2005

(54) Clay-based magnetorheological fluid

(76) Inventors: Robert Augustine Ottaviani, Anthem, AZ (US); John C. Ulicny, Oxford, MI (US); Mark A. Golden, Washington, MI (US); William R. Rodgers, Bloomfield Township, MI (US)

Correspondence Address: KATHRYN A. MARRA;General Motors Corporation, Legal Staff, Mail Code 482-C23-B21, P.O. Box 300, Detroit, MI, 48265-3000, US

(21) Appl. No.: 10/837,937

(22) Filed: May 3, 2004

(51) Int. Cl. H01F 1/28

(52) U.S. Cl. 252/62.52; 192/21.5; 192/84.1

(57) ABSTRACT

A magnetorheological (MR) fluid includes a hydrocarbon carrier fluid. The MR fluid further includes magneto-responsive particles within the hydrocarbon carrier fluid, the particles having a size distribution with a maximum size less than about 100 microns. A clay-based suspending agent is disposed within the hydrocarbon carrier fluid. In an embodiment, the magneto-responsive particles may be ferromagnetic particles, and may be distributed in a suitable size distribution pattern, such as, for example, a bimodal distribution or the like.

### TECHNICAL FIELD

The present invention relates generally to magnetorheological fluids, and more particularly to magnetorheological fluids having clay based-suspending agents.

### BACKGROUND OF THE INVENTION

Magnetorheological (MR) fluids are responsive to magnetic fields and contain a field polarizable particle component and a liquid carrier component. MR fluids are useful in a variety of mechanical applications including, but not limited to, shock absorbers, controllable suspension systems, vibration dampeners, motor mounts, and electronically controllable force/torque transfer devices.

The particle component of MR fluids typically includes micron-sized magneto-responsive particles. In the presence of a magnetic field, the magneto-responsive particles become polarized and are organized into chains or particle fibrils which increase the apparent viscosity (flow resistance) of the fluid, resulting in the development of a solid mass having a yield stress that must be exceeded to induce onset of flow of the MR fluid. The particles return to an unorganized state when the magnetic field is removed, which lowers the apparent viscosity of the fluid.

Generally, settling of some of the particles is inevitable due to gravity and possibly due to inertial effects in, for example, a clutch device in which the MR fluid may be used. The particle settling phenomenon may, in some instances, be problematic for MR fluids in non-limitative applications such as motor vehicle transmission clutches. This may be due in part to separation of the carrier fluid and particles that may impair function and performance of the MR fluid.

It is also believed that oxidation of the magneto-responsive particles may, in some instances, compromise performance of MR fluids of which they are a component. To date, various attempts have been made to prevent or retard particle oxidation.

### SUMMARY OF THE INVENTION

The present invention substantially solves the problems and/or drawbacks described above by providing a magnetorheological (MR) fluid including a hydrocarbon carrier fluid. The MR fluid further includes magneto-responsive particles within the hydrocarbon carrier fluid, the particles having a size distribution with a maximum size less than about 100 microns. A clay-based suspending agent is disposed within the hydrocarbon carrier fluid. In an embodiment, the magneto-responsive particles may be ferromagnetic particles, and may be distributed in a suitable size distribution pattern, such as, for example, a bimodal distribution or the like.

### BRIEF DESCRIPTION OF THE DRAWINGS

FIG. 1A is a graph of fan speed vs. time for an MR fluid containing clay “B”;

FIG. 1B is a graph of current vs. time for an MR fluid containing clay “B”;

FIG. 1C is a graph of skin temperature (° F.) vs. time for an MR fluid containing clay “B”;

FIG. 2 is a cross sectional perspective view of an embodiment of a clutch mechanism having an embodiment of the MR fluid of the present invention operatively disposed therein;

FIG. 3 is a graph depicting a fan clutch test profile for MR fluids; and

FIG. 4 is a graph depicting clutch durability test speed profiles.

### DESCRIPTION OF THE PREFERRED EMBODIMENT

It would be desirable to provide compositions, formulations, and materials that may function as MR fluids while advantageously providing at least minimal oxidation inhibition of the magneto-responsive particles in the fluid. Further, it would be desirable to provide an MR fluid having a composition that substantially retards separation of the base fluid and the particles. Embodiments of the magnetorheological (MR) fluid of the present invention substantially provide these characteristics.

Without being bound to any theory, it is believed that the inclusion of a clay-based suspending agent in MR fluid compositions according to embodiment(s) of the present invention may allow the MR fluid to form a transient gel-like structure that may substantially aid in impeding separation between the carrier fluid and the magneto-responsive particles when a gravitational field is exerted on the MR fluid.

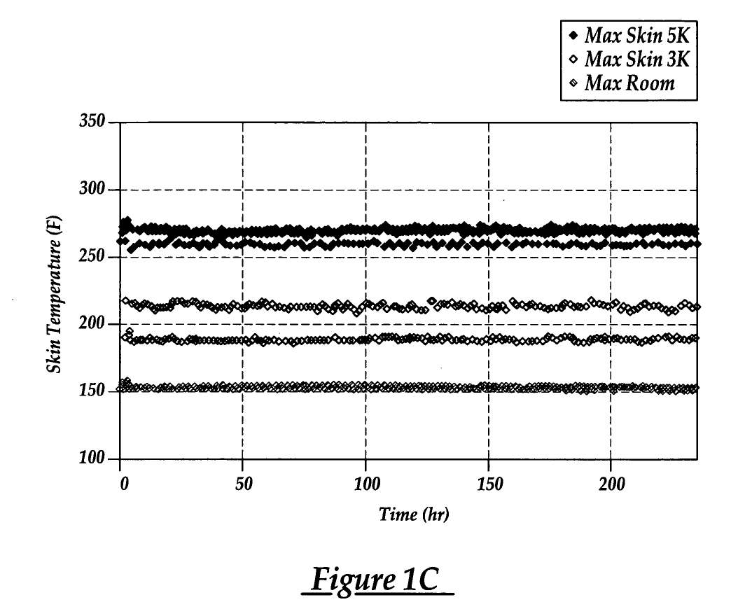

The magnetorheological fluid (designated 10 in FIG. 2) disclosed herein includes magneto-responsive particles together with a clay-based suspending agent in a hydrocarbon carrier fluid. In an embodiment, the hydrocarbon carrier fluid may be a synthetic hydrocarbon-based fluid. The hydrocarbon carrier fluid of choice in embodiments of the present invention is one which is sufficient to act as a suitable carrier fluid for the magneto-responsive particles and the clay-based suspending agent(s) contained therein. Suitable carrier fluids useful in embodiments of the composition of the present invention are those that can suspend the magneto-responsive particles but are essentially nonreactive therewith.

Examples of suitable hydrocarbon carrier fluids include, but are not limited to, unsaturated and saturated naturally occurring hydrocarbon oils, saturated and unsaturated synthetic hydrocarbon oils, substituted hydrocarbon oils such as halogenated hydrocarbons, blends thereof, and/or mixtures thereof. Non-limitative examples of suitable hydrocarbon oils include mineral oils, paraffin oils, cyclo-paraffin oils (also known as naphthenic oils), synthetic hydrocarbon oils, and/or mixtures thereof. Synthetic hydrocarbon oils may include, but are not limited to those oils derived from the oligomerization of olefins such as polybutenes and oils derived from higher alpha olefins of from about 8 to about 20 carbon atoms by acid catalyzed dimerization, and by oligomerization using tri-aluminum alkyls as catalysts. Such polyalpha olefin oils may be employed as carrier fluids in embodiment(s) of the present invention. It is also contemplated that oils derived from vegetable materials may be employed as carrier fluids in embodiment(s) of the present invention. In embodiments of the present invention, it may be desirable to employ carrier fluids that are amenable to recycling and/or reprocessing, as desired and/or required.

The carrier fluids of choice in embodiment(s) of the present invention include, but are not limited to carrier fluids having a viscosity between about 2 and about 1,000 centipoise at 25° C.; a viscosity between about 3 and about 200 centipoise at 25° C.; and/or a viscosity between about 5 and about 100 centipoise at 25° C.

It is to be understood that the hydrocarbon carrier fluid according to embodiments of the present invention may be present in any suitable amount. However, in an embodiment, the carrier fluid is present in an amount ranging between about 5 weight percent and about 45 weight percent.

In an embodiment, it is contemplated that the carrier fluid portion and magneto-responsive particles may be admixed to provide a composition having magneto-responsive particles present in an amount ranging between about 5 and about 60 percent by volume (about 30 to about 95 percent by weight). In an alternate embodiment, the magneto-responsive particles may be present in an amount ranging between about 10 and about 45 percent by volume (about 50 to about 90 percent by weight). In a further embodiment, the magneto-responsive particles may be present in an amount ranging between about 20 and about 45 percent by volume (about 70 to about 90 percent by weight). In an embodiment, the carrier fluid and particle components of the magnetorheological fluid has a specific gravity ranging between about 0.8 and about 0.9. In an alternate embodiment, the carrier fluid and particle components of the magnetorheological fluid have a specific gravity ranging between about 0.7 and about 0.95 for the fluid components and between about 7.0 and about 8.0 for the particle components. In an alternate embodiment, the carrier fluid and particle components of the magnetorheological fluid have a specific gravity ranging between about 0.75 and about 0.8 for the fluid components and between about 7.5 and about 8.0 for the particle components.

An embodiment of a suitable hydrocarbon carrier fluid may advantageously allow the device(s) employing embodiment(s) of the MR fluid of the present invention to operate satisfactorily at low ambient temperatures. One non-limitative example of a suitable carrier fluid may advantageously permit operation of the associated device(s) at temperatures as low as about −40° C. An alternate non-limitative example of a suitable carrier fluid may advantageously permit operation of the associated device(s) at temperatures as low as about −20° C. Examples of suitable hydrocarbon carrier fluids will possess suitable characteristics and properties to enable such extreme cold functionality. In embodiments of the MR fluid of the present invention, it is contemplated that the hydrocarbon carrier fluid will have a molecular weight adapted to provide extreme cold functionality while maintaining magnetorheological functionality. In embodiments of the present invention where poly-alphaolefinic hydrocarbons are utilized, it is contemplated that the molecular weight of the carrier fluid will be less than about 500, with a molecular weight between about 280 and about 450 being preferred.

The magnetorheological (MR) fluid according to embodiments of the present invention has an effective amount of magneto-responsive particles contained in the hydrocarbon carrier fluid. The magneto-responsive particles, as that term is used herein, are those particles exhibiting a magnetorheological effect under use conditions in devices such as shock absorbers, controllable suspension systems, vibration dampeners, motor mounts, electronically controllable force/torque transfer devices, and the like. One non-limitative example of a device utilizing an embodiment of the MR fluid of the present invention is a clutch, such as an automotive fan clutch.

As disclosed herein, the magneto-responsive particles may be particles that are magnetizable, ferromagnetic, have low coercivity (i.e., little or no residual magnetism when the magnetic field is removed), finely divided particles of iron, nickel, cobalt, iron-nickel alloys, iron-cobalt alloys, iron silicon alloys, combinations thereof, and/or the like. The materials may be spherical or nearly spherical in shape and have a diameter in the range of about 0.01 to about 100 microns, with diameters in a range between about 1 and about 20 microns being preferred in an embodiment of the present invention. In an embodiment of the MR fluid of the present invention where the particles are employed in noncolloidal suspensions, the particles are at the small end of the suitable range, ranging between about 0.5 and about 30 microns in nominal diameter or particle size, with diameters between about 1 and about 20 microns being preferred.

In an embodiment of the MR fluid of the present invention, the magneto-responsive particles are an iron powder. The iron powder may be any form of powdered iron, including but not limited to carbonyl iron, reduced carbonyl iron, crushed iron, milled iron, melt-sprayed iron, iron alloys, and/or mixtures thereof. Non-limitative examples of suitable carbonyl iron particles are described in U.S. Pat. No. 5,667,715 issued to Foister. In embodiments of the method and fluid of the present invention, the particle materials are carbonyl iron and reduced carbonyl iron. Suitable carbonyl iron is derived from the thermal decomposition of iron pentacarbonyl (Fe(CO)₅). Carbonyl iron materials typically contain greater than about 97% iron, with carbon content less than about 1%; oxygen content less about than 0.5%, and nitrogen content less than about 1%.

Examples of other iron alloys which may be used as magneto-responsive particles include, but are not limited to, iron-cobalt and iron-nickel alloys. Iron-cobalt alloys may have an iron-cobalt ratio ranging from about 30:70 to about 95:5; and/or from about 50:50 to about 85:15. The iron-nickel alloys may have an iron-nickel ratio ranging from 90:10 to about 99:1; and/or from about 94:6 to 97:3. The iron alloys may contain a small amount of other elements such as vanadium, chromium, etc., in order to improve ductility and mechanical properties of the alloys. These other elements are typically present in amounts less than about 3.0 percent total by weight.

In an embodiment of the present invention, the particles are typically in the form of metal powders. Average particle diameter distribution size of embodiments of the magneto-responsive particles ranges between about 1 micron and about 100 microns, with ranges between about 1 micron and about 50 microns being preferred.

The particles may be present in bimodal distributions of large particles and small particles with large particles having an average particle size distribution between about 5 and about 30 microns. Small particles may have an average particle size distribution between about 1 and about 10 microns. In the bimodal distributions as disclosed herein, it is contemplated that the average particle size distribution for the large particles will typically exceed the average particle size distribution for the small particles in a given bimodal distribution. Thus, in situations where the average particle distribution size for large particles is 5 microns, for example, the average particle size distribution for small particles will be below that value. Examples of suitable magnetorheological fluids having bimodal particle distributions include, but are not limited to those disclosed in U.S. Pat. No. 5,667,715 issued to Foister, the specification of which is incorporated herein in its entirety.

It is to be understood that the particles may be spherical in shape. However, it is also contemplated that magneto-responsive particles may have irregular or nonspherical shapes as desired and/or required. Additionally, a particle distribution of nonspherical particles as disclosed herein may have some nearly spherical particles within its distribution. Where carbonyl iron powder is employed, it is contemplated that a significant portion of the particles may have a spherical or near spherical shape.

It is contemplated that the magneto-responsive particles may be present in the carrier fluid in either monomodal or bimodal particulate distribution. The term “bimodal” is employed to mean that the population of solid particles employed in the fluid possesses two distinct maxima in their size and/or diameter distributions-for example, a small size and/or diameter distribution and a large size and/or diameter distribution. The bimodal particles may be spherical or generally spherical. The large diameter/size particle group will have a large mean diameter/size with a standard deviation generally no greater than about two-thirds of the mean diameter/size. Likewise, the smaller particle group will have a small mean diameter/size with a standard deviation generally no greater than about two-thirds of that mean diameter/size value.

Preferably, the small particles are at least about one micron in diameter so that they are suspended and function as magneto-responsive particles. In an embodiment, the upper limit on particle size is about 100 microns since particles of greater size generally may not be spherical in configuration, but rather may tend to be agglomerations of other shapes. In an alternate embodiment of the present invention, the mean diameter or most common size of the large particle group is about 5 to about 10 times the mean diameter or most common particle size in the small particle group. The weight ratio of the two groups may be within 0.1 to 0.9. The composition of the large and small particle groups may be the same, similar, or different. Carbonyl iron particles typically have a spherical configuration and work well for both the small and large particle groups.

It is to be understood that bimodal distributions, where utilized, will be employed in a manner that provides an optimum combination of on-state yield stress and low viscosity. It is also contemplated that monomodal particle distributions may be utilized where appropriate. Similarly, other particle distribution ratios may be employed as desired and/or required.

Non-limitative examples of bimodal distribution ratio ranges include carbonyl iron particles in which the ratio of small iron particles, having an average particle size distribution between about 0.5 and about 10 microns, and large particles, having an average particle size distribution between about 10 and about 30 microns, is between about 25:75 and about 75:25, small particle to large particle respectively.

It is contemplated that the total amount of magneto-responsive particles present in the MR fluid will be that appropriate for achieving the desired magnetorheological effect. It is contemplated that the magneto-responsive particles will be present in the carrier fluid in an amount ranging between about 60 weight % and about 90 weight %, with an amount ranging between about 80 weight % and 90 weight % being preferred.

Where desired and/or required, the magneto-responsive particles may be subjected to any suitable preformulative processes to aid in enhancing performance characteristics such as magnetorheological effect and the like. One such non-limitative example of a suitable magneto-responsive particle treatment is outlined in U.S. Ser. No. 10/647,359 by inventors Ulicny et al., filed Aug. 25, 2003, the specification of which is incorporated herein by reference in its entirety.

Embodiments of the magnetorheological fluid of the present invention further includes a clay-based suspending agent. The term “clay” as used herein is defined to mean a naturally and/or synthetically derived composition composed mainly of hydrous metal silicates. It is to be understood that the clay-based suspending agent may be divided into particles that may be readily integrated into the embodiment of the carrier fluid employed.

While various types of clays may be efficaciously employed, the clay-based suspending agent, or at least a substantial portion thereof, is composed of a bentonite clay material in an embodiment of the present invention. If desired and/or required, the bentonite clay may be treated with an alkyl quaternary ammonium or a phosphonium ion-exchange compound, resulting in an organoclay compound. One example is SCPX 2446, which is a sodium montmorillonite treated with 95MER (milliequivalent ratio) trihexyl tetradecylphosphonium chloride. A MER is a measure of the amount of intercalant with regard to the ion exchange capacity of the clay. A MER of 100 means that all of the available ion exchange capacity of the raw clay (i.e., the sodium ions) has been exchanged for the intercalant. A MER with quaternary ammonium ions may range between about 75 and about 165. In an embodiment, the MER ranges between about 95 and about 125 for quaternary ammonium ions. It is contemplated that the phosphonium ion exchanged clays may be lower than about 95 MER. Without being bound to any theory, it is believed that the phosphonium based intercalants may be high temperature materials due in part to their degradation kinetics. It is to be understood that the onset decompostion temperature for the quaternary ammonium compounds is about 170° C., while the onset decomposition temperature for the phosphonium compounds is about 260° C. The phosphonium based materials may have a higher start of degradation as compared to the quaternary ammonium ion exchanged materials, which may be advantageous for providing higher temperature stability to the clay. A non-limitative example of a phosphonium exchange material is tetrabutyl phosphonium bromide. It is to be understood that (H(CH₂)X)₄PO₄ where X=2 to 22 or higher may successfully be used in the practice of embodiments of the present invention.

The bentonite clay material employed may provide a substantially softer particle than various silica materials, and thus may advantageously produce less wear of the metal parts of the associated device (e.g. a clutch 20) in which it is used. Further, embodiments of the MR fluid of the present invention employing clay-based suspending agent(s) as disclosed herein may survive device service better than fumed silica formulations without additives.

Non-limitative examples of suitable clay-based suspending agents include organically modified bentonite or montmorillonite clays modified with alkyl quaternary ammonium and/or phosphonium compounds. These are commercially available under the trade names “Claytone EM”, and “SCPX 2446”, each from Southern Clay Products, Inc., located in Gonzales, Tex.

In embodiments of the present invention, the clay-based suspending agent is present in an amount sufficient to maintain at least a portion of the magneto-responsive particles in suspension in the hydrocarbon carrier fluid. It has been found that the clay-based suspending agent may advantageously be efficacious at relatively low concentrations in embodiments of the fluid of the present invention. In an embodiment of the present invention, the amount of clay-based suspending agent ranges between about 0.1 wt. % and about 10.0 wt. % of the magnetorheological fluid. In an alternate embodiment of the present invention, the amount of clay-based suspending agent ranges between about 0.1 wt. % and about 1.0 wt. % of the magnetorheological fluid.

Without being bound to any theory, it is believed that the clay-based suspending agent may form a transitory gel-like structure or microstructure between the hydrocarbon carrier fluid and the clay-based suspending agent during at least a portion of the magnetorheological cycle. It is believed that the formation of the gel-like structure or microstructure may be due in part to the exfoliation of the clay in the carrier fluid. It is further believed that the gel-like structure or microstructure contained within the carrier fluid may function to impede separation of the magneto-responsive particles from the carrier fluid.

The bentonite-type clay material utilized as the clay-based suspending agent in embodiments of the present invention is occasionally referred to as smectite or montmorillonite. Bentonite-type clay material, as that term is used herein, is naturally occurring sodium bentonite. In an embodiment of the present invention, the bentonite-type clay material is organically modified with a suitable modifying agent to yield a suitable organoclay. Suitable modifying agents include, but are not limited to, alkyl-quaternary ammonium compounds appropriate to yield an oleophilic material.

Where desired and/or required, the bentonite-type clay material may be processed to remove unwanted impurities such as iron, silica, and the like. It is contemplated that the bentonite-type clay material is primarily the smectite portion of the bentonite material. Of the smectite portion, it is contemplated that the clay-based suspending agent may be composed of at least one of trioctahedral smectite and dioctahedral smectite. It is to be understood that trioctahedral smectite may be referred to as hectorite, also classified as magnesium silicate, and dioctahedral smectite may be referred to as montmorillonite. Typically montmorillonite, also classified as hydrated sodium calcium aluminum magnesium silicate hydroxide, is in greater prevalence.

Non-limitative examples of suitable clay-based suspending agents may be present as particulate material in colloidal sizes suitable and compatible for use in embodiments of the MR fluid of the present invention. Typical clay-based suspending agent particles will have a particle size less than about 100 microns, and in one embodiment particle sizes range between about 3 microns and about 50 microns.

It is contemplated that the clay-based suspending agent may be incorporated and/or added to embodiments of the MR fluid of the present invention in any manner so as to provide substantially proper dispersion therein. Addition techniques of such materials to hydrocarbon carrier fluids are generally known and may be efficaciously employed herein.

The magnetorheological fluid according to embodiments of the present invention may be capable of being used in various environments. Typically, embodiments of the MR fluid may be advantageously employed in a device having a use temperature ranging between about −40° C. to about +300° C. (the temperature typically being an internal device temperature); a magnetic flux density ranging between about 0 and about 1.6 Tesla; and a gravitational field ranging between about 1 g and about 1,300 g. One non-limitative example of a device utilizing an embodiment of the MR fluid of the present invention is an automotive fan drive clutch in which the ambient temperature is about 65° C. (150° F.), the magnetic flux density is about 0.6 Tesla, and the gravitational field is about 500 g. It is to be understood that the MR fluid withstands not only the ambient temperature but also the transient temperatures generated during the operation of a clutch, which, internally, can reach the range indicated previously.

The MR fluid according to embodiments of the present invention has a low viscosity at the specified temperature ranges. Without being bound to any theory, it is believed that this viscosity characteristic may be primarily due to the hydrocarbon carrier fluid component. The low viscosity is preferably exhibited at the low end of the indicated temperature range so that a device, such as a fan drive, will operate at minimal speed when engine cooling is not required. As previously described, the gravitational field exerted on embodiments of the MR fluid as a consequence of the rotary motion of the device tends to promote particle separation from the carrier fluid. Embodiments of the MR fluid of the present invention include a clay-based suspending agent that may promote formation of gel-like structures or microstructures that are generally robust enough to withstand the artificial gravitational forces, thus substantially impeding particle separation.

Referring now to FIG. 2, a non-limitative embodiment of a clutch mechanism 20 utilizing an embodiment of the MR fluid of the present invention includes a first rotating member 24 and a second rotating member 26. First rotating member 24 may be an input shaft and plate; and second rotating member 26 may be an output shaft and plate. An embodiment(s) of the magnetorheological (MR) fluid 10 as previously described may be operatively disposed between the first 24 and second 26 rotating members. The clutch mechanism 20 may further comprise, among other components known to the skilled artisan, a casing 22; an electromagnetic coil 28; and an electromagnetic core 30 operatively disposed within clutch mechanism 20. When an embodiment(s) of the MR fluid 10 is exposed to a magnetic field, the yield stress of the MR fluid 10 increases by several orders of magnitude. This increase in yield stress may be used to control the fluid coupling between the two rotating members 24, 26 in the clutch.

To further illustrate the present invention, the following examples are given. It is to be understood that these examples are provided for illustrative purposes and are not to be construed as limiting the scope of embodiments of the present invention.

### EXAMPLE I

A synthetic hydrocarbon-based carrier fluid of polyalphaolefin (PAO) having an average molecular weight of about 280 and consisting of a mixture of lower and higher molecular weight species of the same kind was obtained from ExxonMobil located in Irving, Texas under the trade name SHF 21. Iron particles of generally spherical shape and made by the carbonyl iron process were added to the carrier fluid to create a dispersion therein. The small iron particles had an average diameter ranging between about 0.5 and about 10 microns, and the large iron particles had an average diameter ranging between about 1 and 100 microns. The ratio of large to small particles was about 1:1. The MR fluid was prepared according to the process outlined in U.S. Pat. No. 5,667,715 to Foister. A clay-based suspending agent was added to the carrier fluid. The clay-based suspending agent was an alkyl quaternary ammonium bentonite clay material commercially available under the tradename SCPX from Southern Clay Products, Inc. located in Gonzales, Tex. The resulting MR fluid contained about 11 weight % of PAO (weight fraction 0.112), about 88 weight % iron particles (weight fraction of 0.887), and about 1 weight % bentonite organoclay (weight fraction of 0.006).

The resulting material was evaluated and found to exhibit satisfactory performance as a magnetorheological fluid in durability testing.

### EXAMPLES II-V

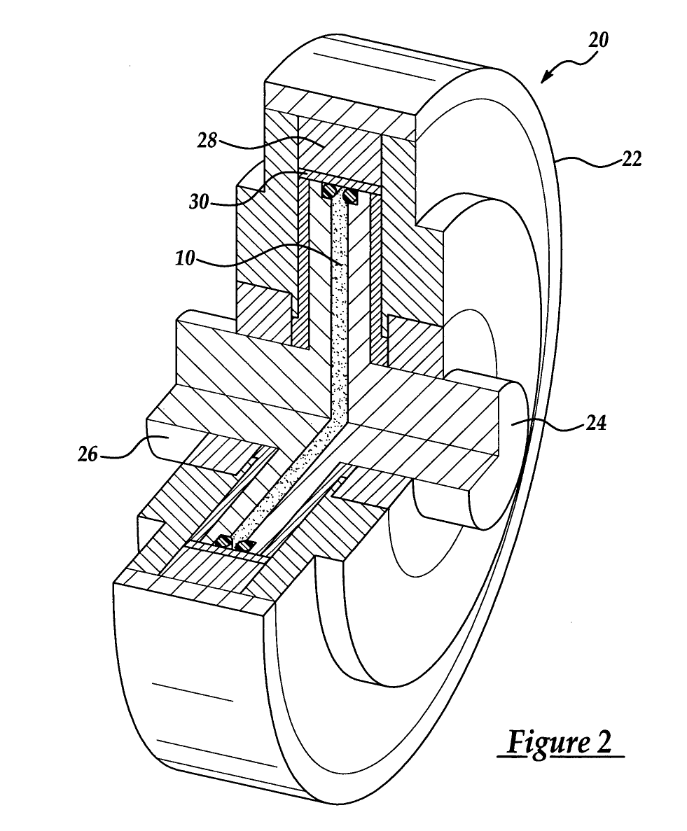

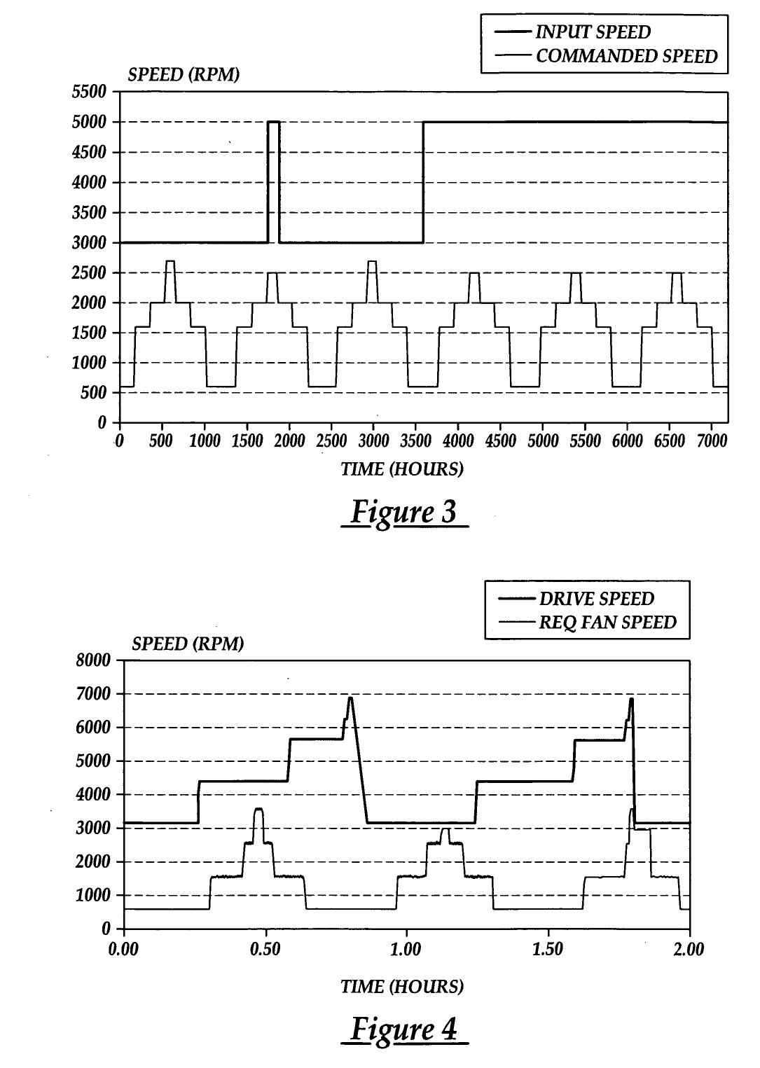

Magnetorheological fluids containing bentonite organoclay material at various clay concentrations were prepared according to the method outlined in Example I. The fluids were tested according to the profile shown in FIG. 3 for standard durability testing, or to the profile shown in FIG. 4 for accelerated durability in fan-driven clutches.

The composition of the various MR fluids and test parameters are outlined in Table 1. MR fluids according to Formulations 1 and 2 exhibited unsatisfactory performance in accelerated durability tests.

Standard durability tests were conducted on Formulations 3 and 4. The performance of these materials provided numerous hours of satisfactory performance when compared to other MR fluids that were tested under similar conditions. The performance of Formulations 3 and 4 demonstrates that different clay formulations vary in performance in durability tests, as shown by the relatively weak performance of Formulations 1 and 2 in the accelerated durability testing.

As depicted in Table 1, clay material “A” is Claytone EM and clay material “B” is SCPX 2446. It is to be understood that some clays are useful for mitigating the oxidation of the magnetic particles in MR fluids in a durability test. As shown in Table 1, Formulations 1 and 2 containing clay “A” demonstrated the ability to maintain lower levels of magnetic particle oxidation over the same period of time as compared to similar formulations without clay “A,” Formulations 3 and 4 being examples of such similar formulations.

TABLE 1

| MR | | | | Fe | Typical | |
|---|---|---|---|---|---|---|
| Fluid | | | | Oxygen | Oxygen | Clay |
| Formu- | | | | Content | Content | Concen- |
| lation | Clay | Test Type | Hours | (%) | (%) | tration^{b} |
| 1 | A | Accelerated | 15 | 0.6 | 1.2 | 0.05 |
| | | Durability | | | | |
| 2 | A | Accelerated | 20 | 0.5 | 1 | 0.03 |
| | | Durability | cycles | | | |
| 3 | B | Standard | 135^{a} | 1.5 | 1.6 | 0.03 |
| | | Durability | | | | |
| 4 | B | Standard | 261 | 0.6 | 0.6 | 0.03 |
| | | Durability | | | | |

^{a}Shutdown on increasing drag speed
^{b}weight ratio of clay to carrier fluid

The magnetorheological fluids were collected upon conclusion of the testing. The fluid samples were visually observed and found to exhibit reduced particle separation.

Additionally, the particles were analyzed to determine oxidation subsequent to performance testing. The data depicted in Table 1 shows that at least a portion of the particles exhibited reduced oxidation.

### EXAMPLE VI

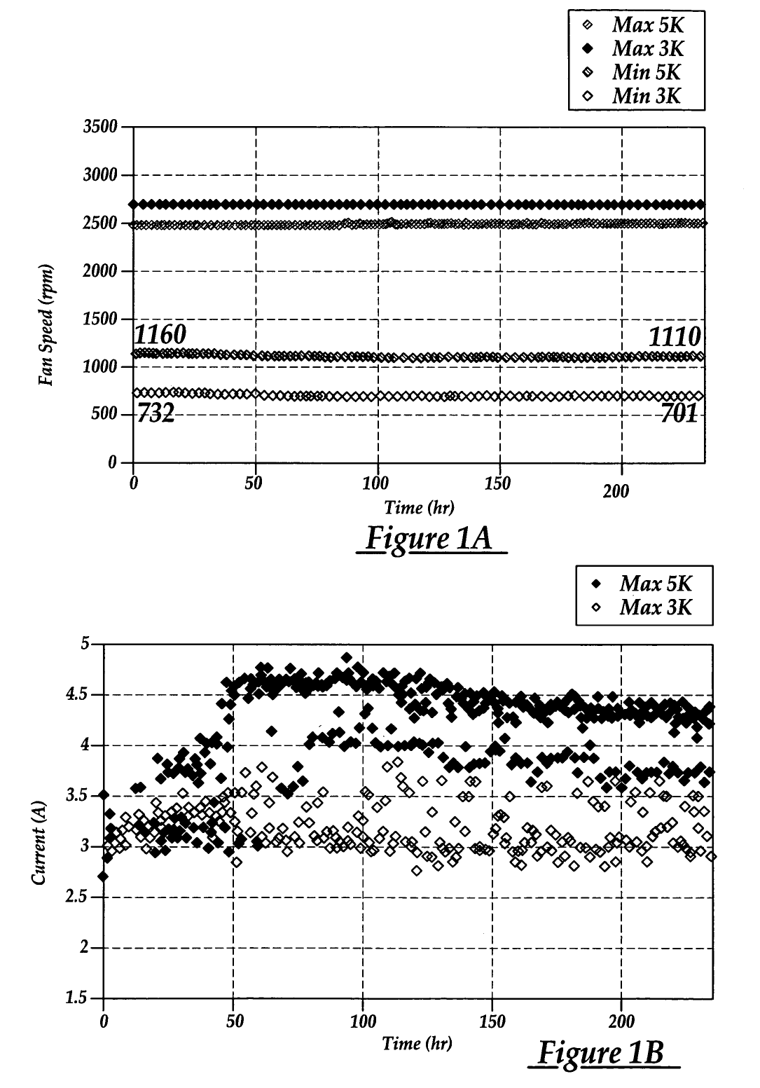

Referring now to FIGS. 1A-1C, a magnetorheological fluid prepared according to Formulation 4 was placed in a large fan clutch (a non-limitative example of a large fan clutch is a fan clutch having a torque capacity on the order of about 40 newton-meters). The MR fluid was cycled and tested according to the procedure outlined in FIG. 3. The MR fluid exhibited satisfactory performance for about 261 hours.

It is believed that the MR fluid according to embodiments of the present invention provides many advantages, examples of which include, but are not limited to improved control of automobile engine cooling; reduced size/weight of an associated device (e.g. a cooling fan clutch); improved fuel economy (when used in a motor vehicle); reduced noise in an automobile passenger compartment (when used in a motor vehicle); less expensive and less complex associated device components; and reduced cooling fan noise even at low temperature (when used in a cooling fan clutch). It is believed that embodiments of the MR fluid of the present invention may advantageously exhibit more robust fluid endurance and reduced oxidation of the iron particles in comparison to known MR fluids (which known fluids do not include the clay-based suspending agent according to embodiments of the present invention).

While embodiments of the invention have been described in connection with what is presently considered to be the most practical and preferred embodiment, it is to be understood that the invention is not limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as permitted under the law.

1. A magnetorheological fluid, comprising:
a hydrocarbon carrier fluid;
magneto-responsive particles within the hydrocarbon carrier fluid, the particles having a size distribution and having a maximum size less than about 100 microns; and
a clay-based suspending agent within the hydrocarbon carrier fluid.

2. The magnetorheological fluid as defined in claim 1 wherein the hydrocarbon carrier fluid has a molecular weight in a range less than about 500:

3. The magnetorheological fluid as defined in claim 1 wherein the hydrocarbon carrier fluid has a viscosity suitable for performance at temperatures down to about −40° C.

4. The magnetorheological fluid as defined in claim 2 wherein the hydrocarbon carrier fluid includes at least one of saturated hydrocarbon oils, unsaturated hydrocarbon oils, mineral oils, paraffins, oils, and cycloparaffin oils.

5. The magnetorheological fluid of claim 4 wherein the hydrocarbon carrier fluid is a synthetic hydrocarbon oil containing poly-alpha olefins, wherein the olefinic group contains between about 8 and about 20 carbon atoms.

6. The magnetorheological fluid of claim 3 wherein the hydrocarbon carrier fluid is a poly-alpha olefin having a viscosity between about 2 and about 1000 centipoise at 25° C.

7. The magnetorheological fluid of claim 1 wherein the magneto-responsive particles include at least one of carbonyl iron particles, reduced carbonyl iron particles, crushed iron, milled iron, melt sprayed iron, iron alloys, and mixtures thereof.

8. The magnetorheological fluid as defined in claim 1 wherein the magneto-responsive particles comprise a ratio of small iron particles and large iron particles, the ratio ranging between about 25 small iron particles to about 75 large iron particles and about 75 small iron particles to about 25 large iron particles.

9. The magnetorheological fluid as defined in claim 8 wherein each of the large iron particles has a diameter ranging between about 1 micron and about 100 microns.

10. The magnetorheological fluid as defined in claim 8 wherein each of the small iron particles has a diameter ranging between about 0.5 microns and about 10 microns.

11. The magnetorheological fluid as defined in claim 1 wherein the clay-based suspending agent is a bentonite clay material including at least one of hectorite and montmorillonite.

12. The magnetorheological fluid of claim 11 wherein the bentonite clay is organically modified.

13. The magnetorheological fluid as defined in claim 1 wherein the clay-based suspending agent is an organoclay present in an amount sufficient to form a gel structure sufficient to impede separation of the carrier fluid and the magneto-responsive particles.

14. The magnetorheological fluid as defined in claim 1 wherein the clay-based suspending agent is present in an amount ranging between about 0.1 weight percent and about 10.0 weight percent.

15. The magnetorheological fluid as defined in claim 1 wherein the hydrocarbon carrier fluid is present an amount ranging between about 5 weight percent and about 45 weight percent.

16. The magnetorheological fluid as defined in claim 1 wherein the magneto-responsive particles are present in an amount ranging between about 60 weight percent and about 90 weight percent.

17. The magnetorheological fluid as defined in claim 1 wherein the hydrocarbon carrier fluid comprises about 11 wt % of the magnetorheological fluid, the magneto-responsive particles comprise about 88 wt % of the magnetorheological fluid, and the clay-based suspending agent comprises about 1 wt % of the magnetorheological fluid.

18. A magnetorheological fluid, comprising:
a hydrocarbon carrier fluid, the hydrocarbon carrier fluid having a molecular weight in a range less than about 300;
a predetermined ratio of small iron particles and large iron particles, the small iron particles ranging in size between about 0.5 microns and about 30 microns and the large iron particles ranging in size between about 1 micron and about 100 microns; and
a clay-based suspending agent present in an amount sufficient to effectively suspend the iron particles in the hydrocarbon carrier fluid.

19. The magnetorheological fluid as defined in claim 18 wherein the clay-based suspending agent substantially reduces tendency of the iron particles to oxidize.

20. The magnetorheological fluid as defined in claim 18 wherein the clay-based suspending agent comprises at least one of organically modified montmorillonite, organically modified hectorite, and mixtures thereof.

21. A clutch mechanism, comprising:
a first rotating member;
a second rotating member; and
a magnetorheological fluid operatively disposed between the first and second rotating members and controlling fluid coupling therebetween, wherein the magnetorheological fluid comprises:
a hydrocarbon carrier fluid;
iron particles having a size distribution which is at least bi-modal; and
a clay-based suspending agent.

22. The clutch mechanism as defined in claim 21 wherein the hydrocarbon carrier fluid has a molecular weight in a range less than about 450.

23. The clutch mechanism as defined in claim 21 wherein the clay-based suspending agent is a bentonite clay treated with an alkyl quaternary ammonium ion-exchanged compound.

24. The clutch mechanism as defined in claim 21 wherein each of the iron particles are of a size ranging between about 0.5 microns and about 100 microns.

25. The clutch mechanism as defined in claim 21 wherein the clay-based suspending agent is present in an amount ranging between about 0.1 weight percent and about 10.0 weight percent.

26. The clutch mechanism as defined in claim 21 wherein the hydrocarbon carrier fluid is synthetic and is present in an amount ranging between about 10 weight percent and about 40 weight percent.

27. The clutch mechanism as defined in claim 21 wherein the iron particles are present in an amount ranging between about 60 weight percent and about 90 weight percent.

28. The clutch mechanism as defined in claim 21 wherein the hydrocarbon carrier fluid comprises about 11 wt % of the magnetorheological fluid, the iron particles comprise about 88 wt % of the magnetorheological fluid, and the clay-based suspending agent comprises about 1 wt % of the magnetorheological fluid.

29. A clay-based suspending agent adapted for use in a magnetorheological fluid, the magnetorheological fluid comprising:
a hydrocarbon carrier fluid, the hydrocarbon carrier fluid having a molecular weight in a range less than about 300; and
a predetermined ratio of small iron particles and large iron particles, the small iron particles ranging in size between about 0.5 microns and about 30 microns and the large iron particles ranging in size between about 1 micron and about 100 microns;
wherein the clay-based suspending agent is present in an amount sufficient to effectively suspend the iron particles in the hydrocarbon carrier fluid.

30. The magnetorheological fluid as defined in claim 29 wherein the clay-based suspending agent comprises at least one of organically modified montmorillonite, organically modified hectorite, and mixtures thereof.
